(19) United States
(12) Patent Application Publication
(10) Pub. No.: US 2009/0253398 A1
(43) Pub. Date: Oct. 8, 2009

(54) MODULATION AND UPCONVERSION TECHNIQUES

(76) Inventors: Paul B. Sheehy, Easton, PA (US); Walid K. M. Ahmed, Tinton Falls, NJ (US)

Correspondence Address: Tyco Technology Resources, Suite 140, 4550 New Linden Hill Road, Wilmington, DE, 19808-2952, US

(21) Appl. No.: 12/098,243

(22) Filed: Apr. 4, 2008

(51) Int. Cl. H04B 1/26

(52) U.S. Cl. 455/313

(57) ABSTRACT

Techniques are disclosed for producing RF signals from baseband signals. For instance, an apparatus may include an intermediate frequency (IF) signal generation module, and an upconversion module. The IF signal generation module produces an analog IF signal from a digital baseband signal. In turn, the upconversion module generates a radio frequency (RF) output signal from the analog IF signal. The upconversion module may include a translational phase locked loop (PLL) to receive the analog IF signal and to produce the RF output signal. The RF output signal may be for transmission in a wireless communications network, such as a cellular network.

### BACKGROUND

Many devices that transmit wireless signals include components for the generation of radio frequency (RF) frequency signals from information signals. For example, devices employed in communications applications (such as cellular telephony) include components that modulate baseband information signals, and components that upconvert the modulated signals to an RF frequency for wireless transmission. Often, transmitted signals need to comply with various spectral requirements. For example, wireless communications standards (e.g., GSM/EDGE, and so forth) may establish certain wideband noise limits.

Unfortunately, compromises can exist between modulation bandwidth and wideband noise performance. For instance, components that modulate information signals may employ techniques (such as delta-sigma modulation) that produce out-of-band quantization noise. This out-of-band noise will appear in the corresponding upconverted RF signals, even when the upconversion component has sufficient bandwidth. This results in wideband nose limit(s) being exceeded.

A conventional technique for addressing this problem involves reducing the modulation bandwidth and employing severe preemphasis filtering prior to upconversion, and corresponding filtering following upconversion (upconversion filtering). However, this technique has disadvantages. For instance, to avoid distortion, this technique unfortunately requires the preemphasis response and the upconversion filtering response to be closely matched. This matching is typically accomplished by time consuming and costly calibration in the factory.

Accordingly, techniques are needed to overcome such disadvantages.

### SUMMARY

Embodiments involve techniques for producing RF signals from baseband signals. For instance, an apparatus may include an intermediate frequency (IF) signal generation module, and an upconversion module. The IF signal generation module produces an analog IF signal from a digital baseband signal. This IF signal is directly provided to the upconversion module. In turn, the upconversion module generates a radio frequency (RF) output signal from the analog IF signal. In embodiments, the upconversion module may include a translational phase locked loop (PLL) to receive the analog IF signal and to produce the RF output signal. The RF output signal may be for transmission in a wireless communications network.

In embodiments, the IF signal generation module may include a modulation module that produces a modulated signal from the digital baseband signal, and a post-processing module to generate the analog IF signal from the modulated signal. The modulated signal may be digital or analog. Accordingly, when the modulated signal is analog, the post-processing module may include an analog to digital converter.

In addition, the apparatus may include an output stage that receives the RF output signal. The output stage may include a power amplifier (PA) that produces an amplified RF signal from the RF output signal. Also, the output stage may include a module that controls one or more operational characteristics of the PA based on characteristics of the amplified RF signal.

Also, in embodiments, a method produces a modulated signal from a digital baseband signal, generates an analog IF signal from the modulated signal, and directly upconverts the analog IF signal to a radio frequency (RF).

Further features are described in the following description and accompanying drawings.

### BRIEF DESCRIPTION OF THE DRAWINGS

FIG. 1 is a diagram of an exemplary apparatus;

FIGS. 2-4 are diagrams of exemplary IF signal generation module implementations;

FIG. 5 is a diagram of an exemplary upconversion module implementation;

FIG. 6 a diagram of an exemplary output stage implementation; and

FIG. 7 is a diagram of an exemplary oscillator module implementation.

### DETAILED DESCRIPTION

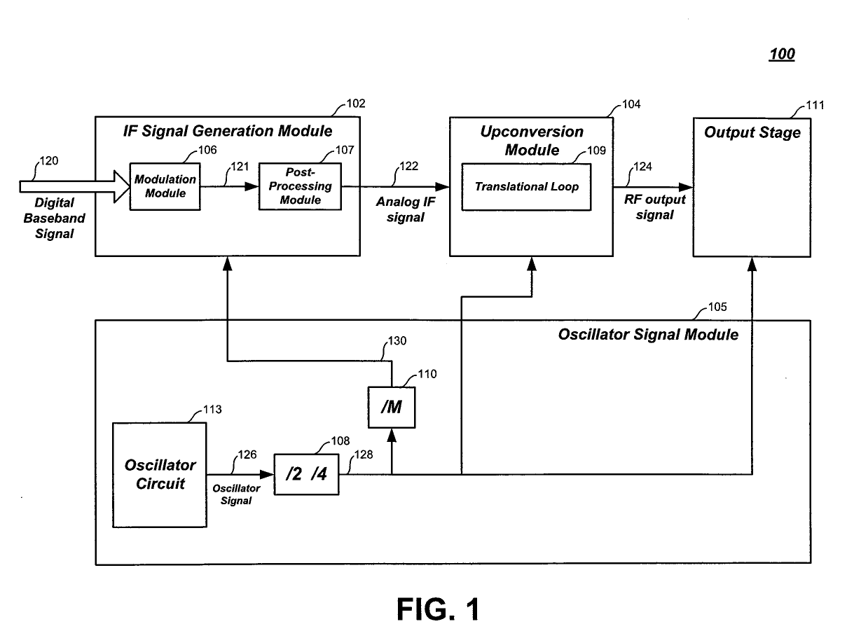

FIG. 1 is a diagram illustrating an apparatus 100 that may operate according to the techniques described herein. Apparatus 100 may include various elements. For example, FIG. 1 shows apparatus 100 including an intermediate frequency (IF) signal generation module 102, an upconversion module 104, an output stage 111, and an oscillator signal module 105. These elements may be implemented in hardware, software, firmware, or any combination thereof.

Apparatus 100 performs operations involving the generation of RF signals from digital baseband signals. For instance, FIG. 1 shows that IF signal generation module 102 receives a digital baseband signal 120 and produces a modulated analog signal at an intermediate frequency (IF). This signal is referred to herein as analog IF signal 122. Analog IF signal 122 is sent to upconversion module 104. Upon receipt, upconversion module 104 upconverts this signal into an analog RF output signal 124. In embodiments, RF output signal 124 may be transmitted wirelessly via an antenna (not shown).

RF output signal 124 has a higher frequency than the frequency of analog IF signal 122. Moreover, RF output signal 124 may be within various frequency bands designated for wireless communications. Exemplary bands include the GSM850 band from 824 MHz to 849 MHz, the EGSM900 band from 880 MHz to 915 MHz, the European DCS band from 1710 MHz to 1785 MHz and the PCS band from 1850 MHz to 1910 MHz. The embodiments, however, are not limited to these frequency bands.

As shown in FIG. 1, IF signal generation module 102 includes a modulation module 106, and a post-processing module 107. Modulation module 106 receives digital baseband signal 120 and produces a modulated signal 121. In embodiments, modulated signal, 121 may a digital signal that includes a sequence of discrete values.

Modulation module 106 may be implemented with digital circuitry. Alternatively, these elements may be implemented as control logic or instructions (e.g., software) that are executed by a processor (not shown). In embodiments, such a processor may be a special purpose digital signal processor (DSP). However, general purpose processors may also be employed. The control logic or instructions may be stored in a storage medium (e.g., memory) accessible to the processor.

FIG. 1 shows that modulated signal 121 is sent to post-processing module 107, which performs various operations on this signal. Examples of such operations include (but are not limited to) analog to digital conversion, filtering, and/or limiting operations. As a result, post-processing module 107 produces analog IF signal 122, which is sent to upconversion module 104.

Post-processing module 107 may be implemented with analog and/or digital circuitry. Further, features of post-processing module 107 may be implemented as control logic or instructions (e.g., software) that are executed by a processor (not shown), such as a special purpose (DSP) and/or a general purpose processor. The control logic or instructions may be stored in a storage medium (e.g., memory) accessible to the processor.

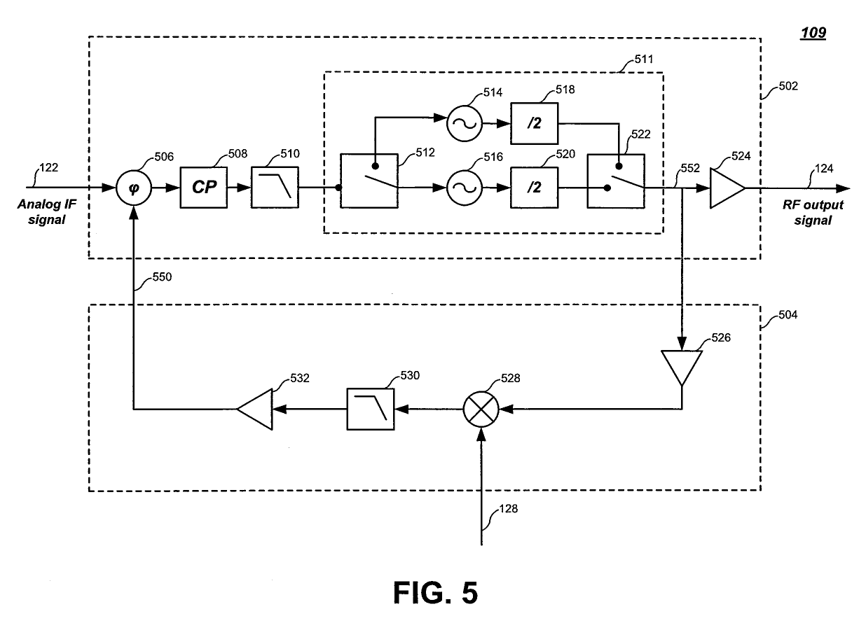

As described above, upconversion module 104 receives analog IF signal 122 from IF signal generation module 102. From this, upconversion module 104 upconverts analog IF signal 122 into corresponding RF output signal 124. As shown in FIG. 1, upconversion module 104 may include a translational phase locked loop 109 (also referred to as a translational loop) to perform this upconversion. An exemplary implementation of translational loop 109 is described below with reference to FIG. 5.

FIG. 1 shows that oscillator signal module 105 includes an oscillator circuit 113, a frequency divider circuit 108, and a frequency divider circuit 110. Oscillator circuit 113 generates an oscillator signal 126. Oscillator signal 126 is sent to frequency divider circuit 108, which produces an oscillator signal 128. As shown in FIG. 1, oscillator signal 128 is sent to upconversion module 104. In addition, oscillator signal 128 is sent to output stage 111.

In generating oscillator signal 128, frequency divider circuit 108 may divide the frequency of oscillator signal 126 by various amount(s). For purposes of illustration (and not limitation), FIG. 1 shows that the frequency of oscillator signal 128 may selectively be either one-half of the frequency of oscillator signal 126 (also referred to as RF high) or one-quarter of the frequency of oscillator signal 126 (also referred to as RF low).

This selection may be based on desired properties of RF output signal 124. For instance, in the context of GSM/EDGE cellular communications, RF high may be selected for high band operations, while RF low may be selected for low band operations. The embodiments, however, are not limited to these fractions, or to selectable fractions.

In addition to being sent to upconversion module 104, oscillator signal 128 is also sent to frequency divider circuit 110. This circuit divides the frequency of signal 128 by a predetermined integer M, and produces oscillator signal 130.

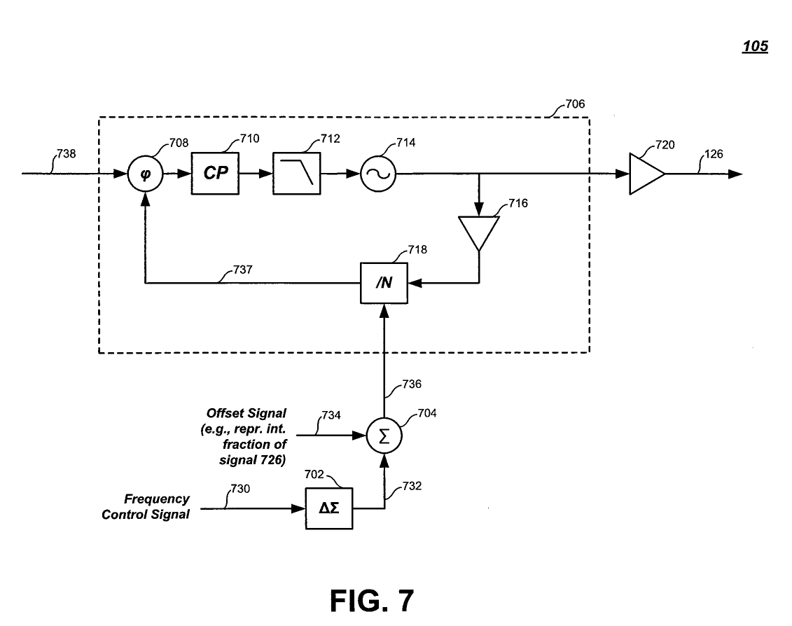

In embodiments, modules 102 and 104 have operational characteristics determined by oscillator signals 130 and 128, respectively. As described above, these oscillator signals are derived from an oscillator signal 126, which is produced by oscillator circuit 113. An exemplary implementation of oscillator circuit 113 is described below with reference to FIG. 7. However, signals 126, 128, and 130 (as well as the techniques of their generation) are shown for purposes of illustration, and not limitation. Therefore embodiments are not limited to these signals and/or their generation techniques.

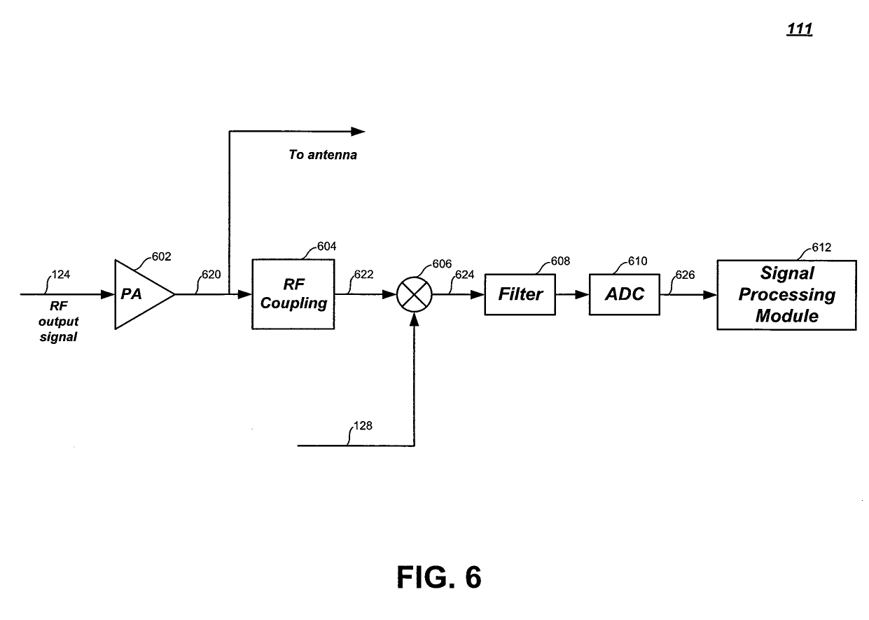

As shown in FIG. 1, output stage 111 receives RF output signal 124. Upon receipt of this signal, output stage 111 may perform various operations. For instance, output stage 111 may amplify RF output signal 124 and send the resulting amplified signal to an antenna (not shown) for wireless transmission. Also, output stage 111 may perform various operations (such as power control) based on characteristics of this amplified signal. This may involve employing oscillator signal 128 to downconvert the amplified signal. Embodiments, however, are not limited to these examples. An exemplary implementation of output stage 111 is described below with reference to FIG. 6.

As described above, apparatus 100 generates an RF signal (RF output signal 124) from a baseband information signal (digital baseband signal 120). Conventional techniques for generating RF signals from information signals involve direct upconversion of modulated signals to an RF frequency. As discussed above, this presents several disadvantages associated with the generation of out-of-band noise.

In embodiments, however, an intermediate frequency (IF) signal (e.g., analog IF signal 122) is generated from a baseband information signal (e.g., digital baseband signal 120). The IF signal is then upconverted to an RF signal (e.g., RF output signal 124).

Further, embodiments may reduce out-of-band noise by employing various techniques, such as IF filtering and/or direct digital synthesis (DDS) of analog IF signals. Such techniques may avoid the employment of preemphasis filtering, as discussed above. Thus, IF signals (e.g., analog IF signal 122) may be directly upconverted to RF frequencies. Thus, in the context of FIG. 1, IF signal generation module 102 provides analog IF signal 122 directly to upconversion module 104. Accordingly, in embodiments, costly and time consuming matching of preemphasis filters and upconversion filters is not required.

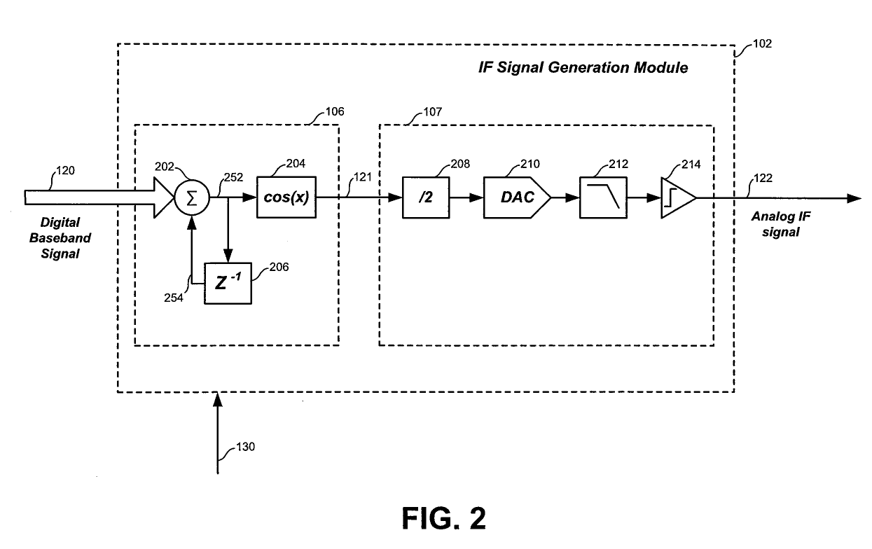

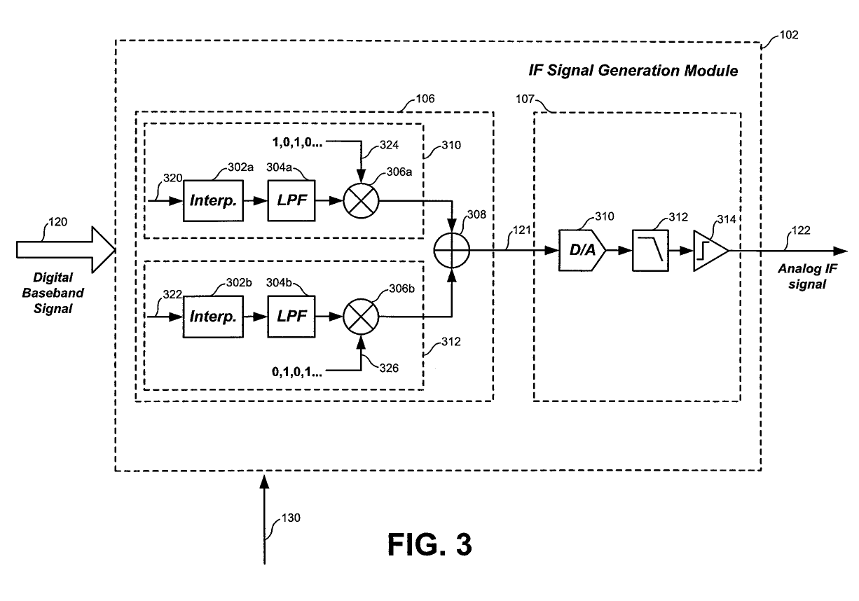

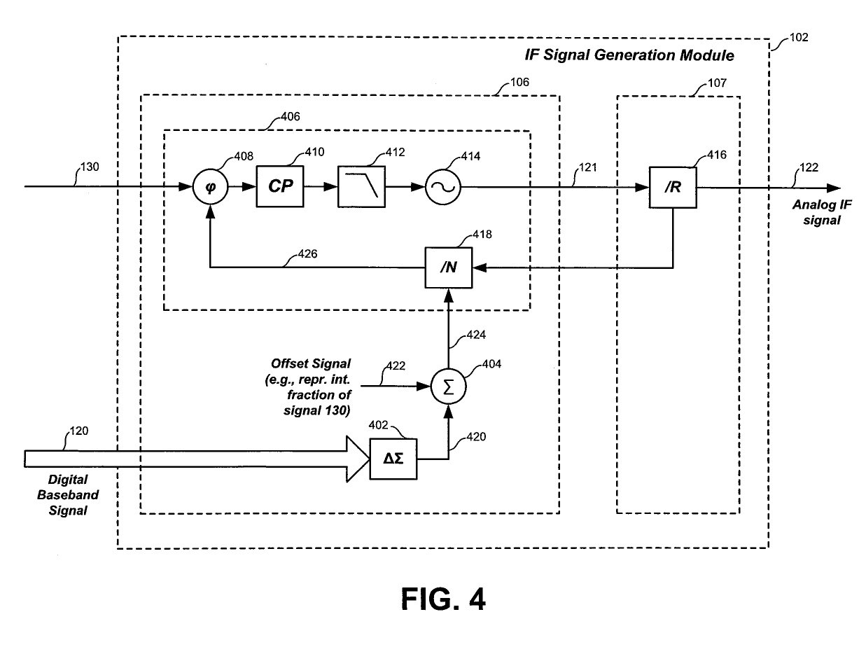

IF signal generation module 102 may be implemented in various ways. Exemplary implementations are described below with reference to FIGS. 2-4. More particularly, FIGS. 2 and 3 provide examples involving direct digital synthesis of IF signals, while FIG. 4 provides an example involving IF signal generation through a phase locked loop. These implementations are provided for purposes of illustration, and not limitation. Accordingly, embodiments are not limited to these implementations.

FIG. 2 is a diagram showing an exemplary implementation of IF signal generation module 102. This implementation involves phase modulation. Thus, digital baseband signal 120 represents phase values. More particularly, digital baseband signal 120 may comprise two component values: a constant phase value; and a time varying phase offset value that conveys information.

As described above with reference to FIG. 1, IF signal generation module 102 includes modulation module 106, and post-processing module 107. In the implementation of FIG. 2, modulation module 106 includes a summation node 202, a cosine operator 204, and a delay element 206. Summation node 202 receives digital baseband signal 120 and a time delayed feedback signal 254. Summation node 202 combines (e.g., adds) these received signals and produces a combined signal 252. As shown in FIG. 1, combined signal 252 is sent to delay element 206 to produce time delayed feedback signal 254.

Thus, combined signal 252 represents an accumulation or integration of digital baseband signal 120. In embodiments, combined signal 252 represents an angular rotation at a particular frequency. This angular rotation exhibits phase variations based on the time varying phase offset portion of digital baseband signal 120.

Cosine operator 204 receives combined signal 252 and produces a sinusoid based on combined digital signal 252. Thus, through this operation, cosine operator 204 performs phase modulation to generate digital signal 121.

As implemented in FIG. 2, post-processing module 107 includes a frequency dividing element 208, a digital to analog converter (DAC) 210, a low pass filter 212, and a hard limiter 214.

Frequency dividing element 208 reduces the frequency of digital signal 121. In particular, FIG. 2 shows the frequency of digital signal 121 being halved. However, embodiments are not limited to this. Following this frequency division, DAC 210 converts the frequency-divided signal into an analog signal. The analog signal is then filtered by low pass filter 212 and hard limited by limiter 214. In embodiments, this hard limiting is performed to eliminate any amplitude variations. As shown in FIG. 2, these operations result in the generation of analog IF signal 122.

FIG. 2 shows IF signal generation module 102 receiving oscillator signal 130. This signal may be used as a clock signal to drive various digital operations. Embodiments, however, are not limited to this example.

FIG. 3 is a diagram showing a further exemplary implementation of IF signal generation module 102. This implementation involves quadrature phase shift keying (QPSK). Accordingly, baseband digital signal 120 represents in-phase (I) and quadrature (Q) component values.

In the implementation of FIG. 3, modulation module 106 includes interpolation (or upsampling) modules 302a-b, low pass filters 304a-b, and mixers 306a-b. These elements are arranged in two paths: an I-path 310, and a Q-path 312. In addition, modulation module 106 includes a combining node 308.

As indicated above, for the implementation of FIG. 3, digital baseband signal 120 represents I and Q component values. Thus, digital baseband signal 120 is shown comprising an in-phase component digital signal 320, and a quadrature component digital signal 322. Signals 320 and 322 are sent to I-path 310 and Q-path 312, respectively.

Each of paths 310 and 312 performs interpolation (e.g., upsampling) and low-pass filtering operations. Within path 310, these operations are performed by elements 302a and 304a. However, in path 312, these operations are performed by elements 302b and 304b.

Following these operations, each of paths 310 and 312 performs a mixing operation with a corresponding modulating signal. For instance, mixer 306a (within path 310) performs a mixing operation with the output of low pass filter 304a and a modulating signal 324. Similarly, mixer 306b (within path 312) performs a mixing operation with the output of low pass filter 304b and a modulating signal 326.

Modulating signals 324 and 326 may each be digital sequences that are out-of-phase with each other. For example, FIG. 3 shows signals 324 and 326 being out-of-phase sequences of alternating ones and zeroes. In embodiments, signals 324 and 326 may be generated through flip-flop or bit-flipping techniques. However, other sequences, as well as other generation techniques, may be employed.

From these mixing operations, mixers 306a and 306b each generate output signals that are combined (e.g., summed) at combining node 308. This combining generates modulated signal 121, which is sent to post-processing module 107.

As implemented in FIG. 3, post-processing module 107 includes a digital to analog converter (DAC) 310, a low pass filter 312, and a limiter 314.

DAC 310 converts signal 121 into an analog signal. This analog signal is then filtered by low pass filter 312 and hard limited by limiter 314. In embodiments, this hard limiting is performed to eliminate any amplitude variations. As shown in FIG. 3, these filtering and hard limiting operations result in the generation of analog IF signal 122.

FIG. 3 shows IF signal generation module 102 receiving oscillator signal 130. This signal may be used as a clock signal to drive various digital operations. Embodiments, however, are not limited to this example.

FIG. 4 is a diagram providing a further exemplary implementation of IF signal generation module 102. As shown in FIG. 4, this implementation may include a delta-sigma modulator 402, a combining node 404, and a phase locked loop (PLL) 406 within modulation module 106. In addition, this implementation may include a frequency divider circuit 416 within post-processing module 107.

Delta-sigma modulator 402 receives digital baseband signal 120 and produces a corresponding analog signal 420, which is sent to combining node 404.

Combining node 404 combines (e.g., adds) analog signal 420 with an analog offset signal 422. This combining produces a frequency division control signal 424, which is sent to a frequency divider circuit within phase locked loop 406. FIG. 4 shows that, for such frequency division, offset signal 422 may represent an integer fraction of the frequency of oscillator signal 130.

As shown in FIG. 4, phase locked loop 406 includes a phase detector 408, a charge pump 410, a low pass filter 412, a voltage controlled oscillator (VCO) 414, and a frequency divider circuit 418.

Phase detector 408 detects a phase difference between oscillator signal 130 and a feedback signal 426. In addition, phase detector 408 produces a signal representing this phase difference and sends it to charge pump 410. Upon receipt of this signal from phase detector 408, charge pump 410 produces a corresponding signal, which is sent to low pass filter 412. In turn, low pass filter 412 produces a filtered signal. As shown in FIG. 4, the filtered signal is sent to VCO 414.

VCO 414 produces modulated signal 121. This signal has a frequency that is determined by the magnitude of the filtered signal received from low pass filter 412. As described above, modulated signal 121 is sent to post-processing module 107.

Within post-processing module 107, modulated signal 121 is received by frequency divider circuit 416, which divides its frequency by a divisor R. As a result of this division, frequency divider circuit 416 produces analog IF signal 122.

In addition, FIG. 4 shows that modulated signal 121 is sent to frequency divider circuit 418 within phase locked loop 406. In turn, frequency divider circuit 418 divides the frequency of analog IF signal 122 by a divisor N. As described above, this divisor is established by frequency division control signal 424. Thus, frequency divider circuit 418 produces feedback signal 426, which is sent to phase detector 408.

FIG. 5 is a diagram providing an exemplary implementation of translational loop 109. As described above with reference to FIG. 1, translational loop 109 may be included in upconversion module 104. The implementation of FIG. 5 includes a forward portion 502 and a feedback portion 504. Together, these portions operate as a phase locked loop (PLL) that upconverts analog IF signal 122 to an output frequency. This upconversion results in RF output signal 124.

As shown in FIG. 5, forward portion 502 includes a phase detector 506, a charge pump 508, a low pass filter 510, an oscillator stage 511, and an output amplifier 524. However, other combinations of elements may be employed.

Within forward portion 502, phase detector 506 detects a phase difference between analog IF signal 122 and a feedback signal 550 (which is received from feedback portion 504). Based on this detection, phase detector 506 produces a signal representing this phase difference that is sent to charge pump 508. In turn, charge pump 508 produces a corresponding signal, which is sent to low pass filter 510. From this signal, low pass filter 510 outputs a filtered signal that is sent to a voltage controlled oscillator (VCO) followed by a frequency divider circuit within oscillator stage 511. As a result, oscillator stage 511 produces a signal 552 at a desired output frequency. Signal 552 is amplified by output amplifier 524 to produce RF output signal 124. In addition, signal 552 is sent to feedback portion 504.

In embodiments, oscillator stage 511 may include multiple paths of VCOs and frequency divider circuits. For example, FIG. 5 shows that oscillator stage 511 has a first path comprising a VCO 514 and a frequency divider circuit 518, and a second path comprising a VCO 516 and a frequency divider circuit 520. These paths are provided as examples, and not as limitations. Thus, embodiments may employ any number of paths (including a single path).

As shown in FIG. 5, oscillator stage 511 also includes switches 512 and 522. These switches may select one of the paths within oscillator stage 511 based on a desired frequency for RF output signal 124. For example, in the context of GSM/EDGE systems, one path may be employed for high band transmissions, while the other path may be employed for low band transmissions. The embodiments, however, are not limited to GSM/EDGE transmission bands.

FIG. 5 shows that feedback portion 504 includes an amplifier 526, a mixer 528, a low pass filter 530, and an amplifier 532. However, other combinations of elements may be employed.

As described above, signal 552 is sent to feedback portion 504. More particularly, amplifier 526 receives this signal and produces an amplified signal, which is sent to mixer 528. Mixer 528 mixes this signal with oscillator signal 128. As a result, mixer 528 produces a signal at a lower frequency (e.g., at the frequency of analog IF signal 122).

The signal produced by mixer 528 is filtered by low pass filter 530 to produce a filtered signal. This filtered signal is amplified by amplifier 532 to produce feedback signal 550. As shown in FIG. 5, feedback signal 550 is sent to phase detector 506.

As described above, the implementation of FIG. 5 includes amplifiers 524, 526, and 532. In embodiments, each of these amplifiers operates as a buffer that provides no substantial gain. However, each of these amplifiers may operate according to other characteristics.

FIG. 6 is a diagram showing an exemplary implementation of output stage 111. This implementation includes a power amplifier (PA) 602, an RF coupling 604, a mixer 606, a filter 608, an analog to digital converter (ADC) 610, and a signal processing module 612.

As shown in FIG. 6, PA 602 receives RF output signal 124 and generates an amplified signal 620. Signal 620 may be sent to an antenna (not shown) for wireless transmission. In addition, FIG. 6 shows that RF coupling 604 receives amplified signal 620 and generates a corresponding signal 622. In embodiments, RF coupling 604 may be implemented with a directional coupler. However, other implementations may be employed.

Mixer 606 receives coupled signal 622 and mixes it with oscillator signal 128. This produces a signal 624 at a lower frequency (e.g., at the employed IF frequency). Signal 624 is filtered by anti-aliasing filter 608 and sent to ADC 610. This results in a digital signal 626 that is sent to signal processing module 612.

Upon receipt of digital signal 626, signal processing module 612 may perform one or more operations. For example, signal processing module 612 may determine power characteristics of coupled signal 622, which reflect the power characteristics of amplified signal 620. Based on such determinations, signal processing module 612 may control operational characteristics (e.g., control parameters or settings, such as bias point and/or gain) of PA 602. Embodiments, however, are not limited to these exemplary operations.

FIG. 7 is a diagram providing an exemplary implementation of oscillator circuit 113. As shown in FIG. 7, this implementation may include a delta-sigma modulator 702, a combining node 704, a phase locked loop (PLL) 706, and an amplifier 720.

Delta-sigma modulator 702 receives digital frequency control signal 730 and produces a corresponding analog signal 732, which is sent to combining node 704.

Combining node 704 combines (e.g., adds) analog signal 732 with an analog offset signal 734. This combining produces a frequency division control signal 736, which is sent to a frequency divider circuit within phase locked loop 706. FIG. 7 shows that, for such frequency division, offset signal 734 may represent an integer fraction of the frequency of a reference signal 738.

As shown in FIG. 7, phase locked loop 706 includes a phase detector 708, a charge pump 710, a low pass filter 712, a voltage controlled oscillator (VCO) 714, an amplifier 716, and a frequency divider circuit 418.

Phase detector 708 detects a phase difference between reference signal 738 and a feedback signal 737. Also, phase detector 708 produces a signal representing the detected phase difference and sends it to charge pump 710. Upon receipt of the signal from phase detector 708, charge pump 710 produces a corresponding signal, which is sent to low pass filter 712. In turn, low pass filter 712 produces a filtered signal that is sent to VCO 714.

VCO 714 produces an output signal having a frequency that is determined by the magnitude of the filtered signal received from low pass filter 712. FIG. 7 shows that this output signal is sent to amplifiers amplifier 716 and 720. In embodiments, these amplifiers operate as buffers that provide no substantial gain. However, embodiments are not limited to this example.

Amplifier 716 produces an amplified signal, which is sent to frequency divider 718. In turn, frequency divider circuit 718 divides the frequency of this signal by a divisor M. As described above, this divisor is established by frequency division control signal 736. Thus, frequency divider circuit 718 produces feedback signal 737, which is sent to phase detector 708.

As described above, amplifier 720 receives a signal from VCO 714. From this signal, amplifier 720 produces oscillator signal 126.

While various embodiments of the present invention have been described above, it should be understood that they have been presented by way of example only, and not in limitation. For instance, embodiments are not limited to applications involving GSM/EDGE communications. Moreover, embodiments are not limited to applications involving cellular communications.

Accordingly, it will be apparent to persons skilled in the relevant arts that various changes in form and detail can be made therein without departing from the spirit and scope of the invention. Thus, the breadth and scope of the present invention should not be limited by any of the above-described exemplary embodiments, but should be—defined only in accordance with the following claims and their equivalents.

1. An apparatus, comprising:
an intermediate frequency (IF) signal generation module to produce an analog IF signal from a digital baseband signal; and
an upconversion module to generate a radio frequency (RF) output signal from the analog IF signal;
wherein the IF signal generation module directly provides the analog IF signal to the upconversion module.

2. The apparatus of claim 1, wherein the IF signal generation module includes:
a modulation module to produce a modulated signal from the digital baseband signal; and
a post-processing module to generate the analog IF signal from the modulated signal.

3. The apparatus of claim 2, wherein the modulated signal is a digital phase modulated signal.

4. The apparatus of claim 2, wherein the modulated signal is a digital quadrature phase shift keying (QPSK) signal.

5. The apparatus of claim 2, wherein the modulated signal is an analog phase modulated signal.

6. The apparatus of claim 2:
wherein the modulated signal is an analog signal; and
wherein the post-processing module includes a digital to analog converter (DAC).

7. The apparatus of claim 1, wherein the upconversion module includes a translational phase locked loop (PLL) to receive the analog IF signal and to produce the RF output signal.

8. The apparatus of claim 1, further comprising an output stage;
wherein the output stage includes a power amplifier (PA) to produce an amplified RF signal from the RF output signal.

9. The apparatus of claim 8, wherein the output stage further comprises a module to control one or more operational characteristics of the PA based on characteristics of the amplified RF signal.

10. The apparatus of claim 8, wherein the amplified RF signal is for wireless transmission in a GSM/EDGE communications network.

11. The apparatus of claim 1, further comprising an oscillator module to generate an oscillator signal, wherein the oscillator signal determines a one or more operational characteristics of the upconversion module.

12. A method, comprising:
producing a modulated signal from a digital baseband signal;
generating an analog IF signal from the modulated signal; and
directly upconverting the analog IF signal to a radio frequency (RF).

13. The method of claim 12, wherein the modulated signal is a digital phase modulated signal.

14. The method of claim 12, wherein the modulated signal is a digital quadrature phase shift keying (QPSK) signal.

15. The method of claim 12, wherein the modulated signal is an analog phase modulated signal.

16. The method of claim 12, wherein said upconverting comprises providing the analog IF signal to a translational phase locked loop (PLL).

17. The method of claim 12, wherein the amplified RF signal is for wireless transmission in a GSM/EDGE communications network.

18. The method of claim 12, further comprising providing the RF output signal to a power amplifier (PA).
